(19) United States
(12) Patent Application Publication
(10) Pub. No.: US 2025/0118766 A1
(43) Pub. Date: Apr. 10, 2025

(54) CURRENT COLLECTOR FOIL FOR LIQUID CELL AND LIQUID CELL

(71) Applicant: TOYOTA JIDOSHA KABUSHIKI KAISHA, Toyota-shi (JP)

(72) Inventors: Takahiko NAKANO, Nagoya-shi (JP); Yusuke KINTSU, Miyoshi-shi (JP)

(73) Assignee: TOYOTA JIDOSHA KABUSHIKI KAISHA, Toyota-shi (JP)

(21) Appl. No.: 18/780,773

(22) Filed: Jul. 23, 2024

(30) Foreign Application Priority Data
Oct. 10, 2023 (JP) 2023-175538

(51) Int. Cl. H01M 4/66; H01M 4/70

(52) U.S. Cl. CPC H01M 4/667; H01M 4/661; H01M 4/70

(57) ABSTRACT

A current collector foil for a liquid cell includes: one first electrode foil having a pinhole; a first intervening layer; another first electrode foil having a pinhole; a second intervening layer; and a second electrode foil, the one first electrode foil, the first intervening layer, the other first electrode foil, the second intervening layer, and the second electrode foil being stacked in this order. Either the one first electrode foil and the other first electrode foil or the second electrode foil is a positive electrode foil, and either the one first electrode foil and the other first electrode foil or the second electrode foil, whichever is not the positive electrode foil, is a negative electrode foil.

### CROSS-REFERENCE TO RELATED APPLICATION

This application claims priority to Japanese Patent Application No. 2023-175538 filed on Oct. 10, 2023, incorporated herein by reference in its entirety.

### BACKGROUND

### 1. Technical Field

The present disclosure relates to current collector foils for liquid cells and liquid cells.

### 2. Description of Related Art

Conventionally, current collector foils for liquid cells that are laminates of positive and negative electrode foils have been used in the art.

For example, Japanese Unexamined Patent Application Publication No. 2023-053669 (JP 2023-053669 A) discloses a bipolar current collector. The bipolar current collector includes a positive electrode current collector having an aluminum layer, a negative electrode current collector having a copper layer, and an intervening layer located between the aluminum layer and the copper layer. The copper layer has a thickness of 3 μm to 10 μm. The intervening layer includes a porous alumite portion and nickel portions present in the pores of the alumite portion.

Japanese Unexamined Patent Application Publication No. 2021-136115 (JP 2021-136115 A) discloses a bipolar cell. The bipolar cell includes a first member, a second member, and a stacked electrode assembly disposed therebetween. The stacked electrode assembly includes: a first current collector forming one end face in the stacking direction; a second current collector forming the other end face in the stacking direction; at least one bipolar current collector disposed between the first current collector and the second current collector; and a plurality of power generation elements electrically connected in series via the bipolar current collector between the first current collector and the second current collector. The first current collector is disposed between the first member and the bipolar current collector. The second current collector is disposed between the second member and the bipolar current collector. The first current collector has a first tab. The second current collector has a second tab. When the cell is energized, the first tab generates a greater amount of heat than the second tab. The first member is a cooling member for cooling the first current collector. The first member has better cooling performance than the second member.

### SUMMARY

Conventionally, current collector foils that are laminates of positive and negative electrode foils with an intervening agent therebetween have been used as current collector foils for liquid cells. However, pinholes may be formed during a process of manufacturing a metal foil to be used for the positive and negative electrode foils. When a current collector foil having pinholes in either or both of the positive and negative electrode foils is used for a liquid cell, a through hole extending through the positive electrode foil, the intervening layer, and the negative electrode foil may be formed, and a liquid junction through the through hole may occur in the liquid cell.

The present disclosure was made in view of the above circumstances. The present disclosure provides a current collector foil for a liquid cell that can reduce the number of pinholes extending from one first electrode foil to a second electrode foil, and a liquid cell that can reduce occurrence of a liquid junction.

Means for addressing the above issue includes the following aspects.
(1) A current collector foil for a liquid cell includes: one first electrode foil having a pinhole; a first intervening layer; another first electrode foil having a pinhole; a second intervening layer; and a second electrode foil, the one first electrode foil, the first intervening layer, the other first electrode foil, the second intervening layer, and the second electrode foil being stacked in this order. Either the one first electrode foil and the other first electrode foil or the second electrode foil is a positive electrode foil, and either the one first electrode foil and the other first electrode foil or the second electrode foil, whichever is not the positive electrode foil, is a negative electrode foil.
(2) A liquid cell includes: the current collector foil according to (1); a positive electrode active material layer; a negative electrode active material layer; a separator; and an electrolyte solution.

A current collector foil for a liquid cell that can reduce the number of pinholes extending from one first electrode foil to a second electrode foil and a liquid cell that can reduce occurrence of a liquid junction are thus provided by the present disclosure.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a configuration of a current collector foil according to an embodiment of the present disclosure;

FIG. 2 is a schematic cross-sectional view showing a configuration of a conventional current collector foil; and

FIG. 3 is a schematic cross-sectional view illustrating a current collector foil manufacturing apparatus used for manufacturing a current collector foil according to an embodiment of the present disclosure.

### DETAILED DESCRIPTION OF EMBODIMENTS

An embodiment which is an example of the present disclosure will be described. These descriptions and examples are illustrative of the embodiments and are not intended to limit the scope of the disclosure. In the present specification, a numerical range expressed by using “from” means a range including these numerical values as a lower limit value and an upper limit value. In the numerical ranges described in the present specification in a stepwise manner, the upper limit value of a stepwise numerical range may be replaced with the upper limit value of another stepwise numerical range, or may be replaced with the value shown in the examples. Also, the lower limit of a stepwise numerical range may be replaced by the lower limit of another stepwise numerical range, or may be replaced by the values shown in the examples. In the content, “%” means “% by mass” unless otherwise specified.

Each component may contain a plurality of corresponding substances. When referring to the amount of each component in a composition, when a plurality of substances corresponding to each component are present in the composition, unless otherwise specified, the total amount of the plurality of substances present in the composition is meant. “Process” is included in this term not only as an independent process, but also as long as the desired action of the process is achieved even if it cannot be clearly distinguished from other processes.

### Current Collector Foil for Liquid Cell

A current collector foil (hereinafter, also simply referred to as a “current collector foil”) for a liquid cell according to an embodiment of the present disclosure includes one first electrode foil having a pinhole, a first intervening layer, another first electrode foil having a pinhole, a second intervening layer, and a second electrode foil that are stacked in this order. Either the one first electrode foil and the other first electrode foil or the second electrode foil is a positive electrode foil, and either the one first electrode foil and the other first electrode foil or the second electrode foil, whichever is not the positive electrode foil, is a negative electrode foil. That is, when the one first electrode foil and the other first electrode foil are positive electrode foils, the second electrode foil is a negative electrode foil. When the one first electrode foil and the other first electrode foil are negative electrode foils, the second electrode foil is a positive electrode foil.

That is, in the current collector foil according to the embodiment of the present disclosure, two or more positive electrode foils having pinholes are stacked. Furthermore, a negative electrode layer is stacked on one surface thereof, or two or more negative electrode foils having pinholes are stacked. Further, a positive electrode layer is stacked on one surface thereof.

The current collector foil according to the embodiment of the present disclosure has the above configuration, so that the number of pinholes reaching from the one first electrode foil to the second electrode foil can be reduced. As a result, when the current collector foil is used in a liquid cell, generation of a through-hole generated in the current collector foil can be suppressed, and occurrence of liquid junction in the liquid cell can be suppressed.

Conventionally, a current collector foil in which a positive electrode foil and a negative electrode foil are bonded to each other via an intervening layer (for example, an adhesive layer) has been used. However, in the metal foil used for the positive electrode foil and the negative electrode foil, pinholes (small holes penetrating the metal foil) may occur in the manufacturing process.

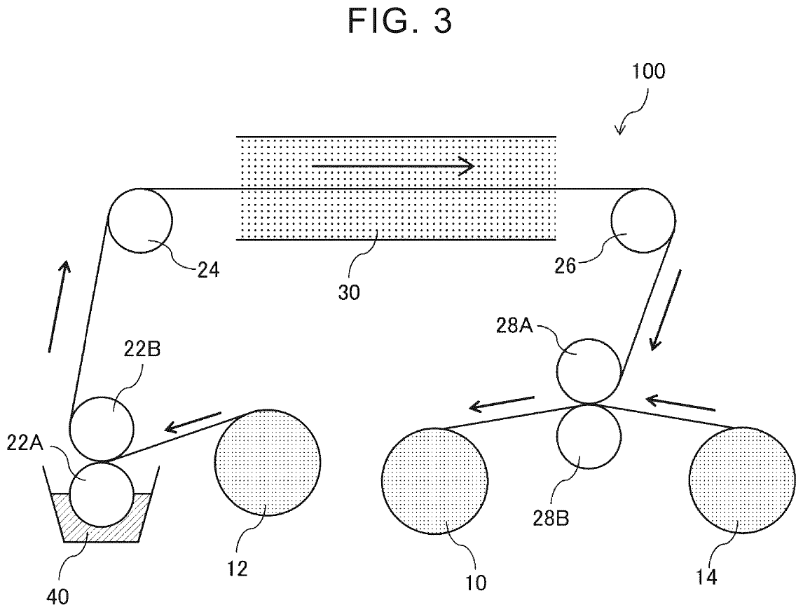

For example, as shown in FIG. 2, a positive electrode foil 112 having a pinhole 1120 is used. In a case where the current collector foil 110 obtained by bonding the positive electrode foil 112 and the negative electrode foil 114 via the intervening layer 140 is used as a liquid cell, a through-hole that penetrates all of the positive electrode foil 112, the intervening layer 140, and the negative electrode foil 114 may be formed at the pinhole 1120 in the positive electrode foil 112. Specifically, in a portion of the positive electrode foil 112 having the pinhole 1120, a hole is also formed in the intervening layer 140 formed on the pinhole 1120, that is, the pinhole 1120 may not be blocked by the intervening layer 140. Then, when the current collector foil 110 obtained by bonding the negative electrode foil 114 to the positive electrode foil 112 and the intervening layer 140 is used as a liquid cell, the electrolyte solution enters the holes penetrating through the positive electrode foil 112 and the intervening layer 140, and the electrolyte solution comes into contact with the negative electrode foil 114. When the cell is repeatedly charged and discharged in this condition, a hole may also be formed in the negative electrode foil 114 due to a reaction with an electrolyte solution (for example, a reaction of Cu→Cu²⁺+2e⁻ when copper foil is used as the negative electrode foil 114). As a result, a through hole that completely extending through the positive electrode foil 112, the intervening layer 140, and the negative electrode foil 114 is formed. In addition, a negative electrode foil having a pinhole is used. In the case where the current collector foil obtained by bonding the negative electrode foil and the positive electrode foil via the intervening layer is used for a liquid cell, a through hole extending through all of the positive electrode foil, the intervening layer, and the negative electrode foil may be formed at the position of a pinhole in the positive electrode foil. Specifically, in a portion having a pinhole of the negative electrode foil, a hole is also formed in an intervening layer formed on the pinhole, that is, the pinhole is not occluded by the intervening layer in some cases. When the current collector foil obtained by bonding the positive electrode foil to the negative electrode foil and the intervening layer is used for the liquid cell, the electrolyte solution enters the holes extending through the negative electrode foil and the intervening layer, and the electrolyte solution comes into contact with the positive electrode foil. When the cell is repeatedly charged and discharged in this state, cracks may occur in the positive electrode foil, and as a result, through-holes completely penetrating the negative electrode foil, the intervening layer, and the positive electrode foil are formed.

Then, in the current collector foil in which the through-holes penetrating the positive electrode foil, the intervening layer, and the negative electrode foil are formed, one side of the current collector foil and the other side of the current collector foil communicate with each other through the through-holes, so that liquid junction occurs.

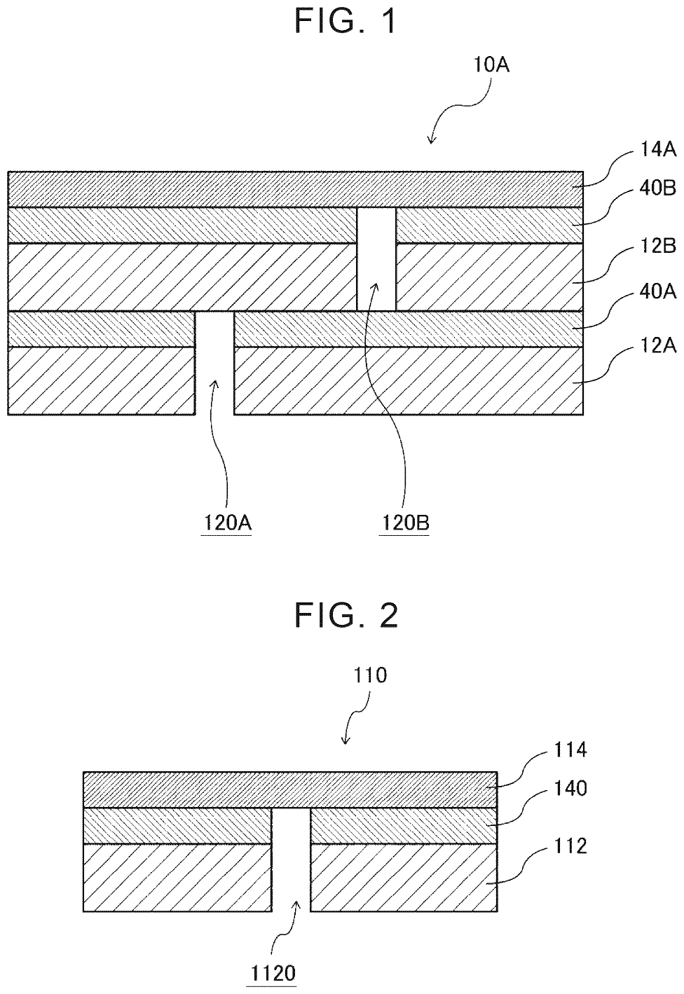

Therefore, in the current collector foil according to the embodiment of the present disclosure, one first electrode foil having a pinhole, a first intervening layer, another first electrode foil having a pinhole, a second intervening layer, and a second electrode foil are stacked in this order. For example, as shown in FIG. 1, a current collector foil 10A having a configuration in which a positive electrode foil 12A having a pinhole 120A, a first intervening layer 40A, a positive electrode foil 12B having a pinhole 120B, a second intervening layer 40B, and a negative electrode foil 14A are stacked in this order can be used. The positive electrode foil 12A and the positive electrode foil 12B have pinholes 120A, 120B, respectively, but the position of the pinhole 120A in the positive electrode foil 12A and the position of the pinhole 120B in the positive electrode foil 12B are extremely unlikely to overlap with each other. That is, by laminating the positive electrode foil 12A having the pinhole 120A and the positive electrode foil 12B having the pinhole 120B, pinholes reaching from the positive electrode foil 12A to the negative electrode foil 14A can be reduced.

As described above, according to the current collector foil of the embodiment of the present disclosure, it is possible to reduce the number of pinholes extending from the one first electrode foil to the second electrode foil. As a result, when the current collector foil is used in a liquid cell, generation of a through-hole generated in the current collector foil can be suppressed, and occurrence of liquid junction in the liquid cell can be suppressed.

### One First Electrode Foil and Another First Electrode Foil

In the current collector foil according to the embodiment of the present disclosure, either the one first electrode foil and the other first electrode foil each having a pinhole or the second electrode foil is a positive electrode foil, and either the one first electrode foil and the other first electrode foil or the second electrode foil, whichever is not the positive electrode foil, is a negative electrode foil. That is, the one first electrode foil and the other first electrode foil each having a pinhole may be either positive electrode foils or negative electrode foils. However, it is a positive electrode foil (particularly an Al foil) that is likely to have pinholes. From the viewpoint of reducing the number of pinholes extending from the one first electrode foil to the second electrode foil due to the pinhole in the positive electrode, the one first electrode foil and the other first electrode foil are preferably positive electrode foils.

The materials etc. of the one first electrode foil and the other first electrode foil are not particularly limited as long as they are both the positive electrode foils or the negative electrode foils. Therefore, the one first electrode foil and the other first electrode foil may be positive electrode foils of different materials, or may be negative electrode foils of different materials. However, it is more preferable that the one first electrode foil and the other first electrode foil be foils of the same material.

The current collector foil according to the embodiment of the present disclosure may further include, in addition to the one first electrode foil and the other first electrode foil, a foil having a pinhole and having the same bending as the one first electrode foil and the other first electrode foil. That is, when the one first electrode foil and the other first electrode foil are positive electrode foils, three or more positive electrode foils each having a pinhole may be stacked. Similarly, when the one first electrode foil and the other first electrode foil are negative electrode foils, three or more negative electrode foils each having a pinhole may be stacked. It may further have the same bent foil as the second electrode foil, that is, in the case where the second electrode foil is a negative electrode foil, two or more layers of the negative electrode foil may be stacked, and in the case where the second electrode foil is a positive electrode foil, two or more layers of the positive electrode foil may be stacked.

### Positive Electrode Foil

As the positive electrode foil used in the embodiment of the present disclosure, a conductive member made of a metal having good conductivity (for example, aluminum) is preferable. The thickness of the positive electrode foil is, for example, preferably 10 μm or more and 100 μm or less, and more preferably 20 μm or more and 60 μm or less.

### Negative Electrode Foil

On the other hand, as the negative electrode foil, a conductive member made of a metal having good conductivity (for example, copper) is preferable. The thickness of the negative electrode foil is, for example, preferably 1 μm or more and 20 μm or less, and more preferably 3 μm or more and 12 μm or less.

### First Intervening Layer and Second Intervening Layer

The first intervening layer and the second intervening layer (hereinafter, also simply referred to as “intervening layer” by referring to both of them) of the current collector foil according to the embodiment of the present disclosure are not particularly limited as long as they have a function to bond the one first electrode foil and the other first electrode foil and bond the other first electrode foil and the second electrode foil. Examples of the intervening layer include a layer of an adhesive (adhesive layer). As the adhesive constituting the adhesive, for example, an adhesive obtained by adding a curing agent (for example, an isocyanate-based curing agent) to a main agent (for example, an olefin-based resin) is preferably used. In addition, a conductive auxiliary agent (for example, Ni plated grains) may be added to the adhesive. The thickness of the intervening layer is not particularly limited, but is, for example, preferably 0.5 μm or more and 15 μm or less, and more preferably 1.0 μm or more and 10 μm or less.

### Manufacturing Method

Next, a method of manufacturing a current collector foil according to an embodiment of the present disclosure will be described with reference to the drawings.

FIG. 3 is a schematic diagram illustrating a current collector foil manufacturing apparatus for manufacturing a current collector foil according to an embodiment of the present disclosure. In the current collector foil according to the embodiment of the present disclosure, for example, one first electrode foil having a pinhole and another first electrode foil having a pinhole are stacked with a first intervening layer interposed therebetween using a current collector foil manufacturing apparatus shown in FIG. 3. Thereafter, the second electrode foil can be stacked on the side of the other first electrode foil with the use of the current collector foil manufacturing apparatus shown in FIG. 3 via the second intervening layer.

Hereinafter, a method of manufacturing a current collector foil according to an embodiment of the present disclosure using the current collector foil manufacturing apparatus shown in FIG. 3 will be specifically described. In the following description, the one first electrode foil having a pinhole is a first aluminum foil (first Al foil) as a positive electrode foil. The other first electrode foil having a pinhole is a second aluminum foil (second Al foil) as a positive electrode foil. The second electrode foil is a copper foil (Cu foil) as a negative electrode foil. A mode in which the first intervening layer and the second intervening layer are the first adhesive layer and the second adhesive layer, respectively, will be described as an example.

### (A1) First Coating Step

First, in the current collector foil manufacturing device 100 shown in FIG. 3, a first Al foil is used as the base foil 12, a second Al foil is used as the lamination foil 14, and an adhesive for forming a first adhesive layer is used as the adhesive 40. The first Al foil, which is the base foil 12, is conveyed to a roll pair composed of a coating roll 22A (for example, a gravure roll) and a counter roll 22B. A portion of the coating roll 22A is immersed in the adhesive 40. The adhesive 40 (adhesive for forming the first adhesive layer) adhered to the surface of the coating roll 22A is applied (for example, gravure applied) to one surface of the base foil 12 (first Al foil) from the coating roll 22A.

### (A2) First Drying Step

Next, the base foil 12 (first Al foil) having passed through the contacting position with the coating roll 22A is conveyed to the drying oven 30 via the conveyance roll 24. In the conveyance path 30, the adhesive 40 on the base foil 12 (first Al foil) is heated in the drying oven 30 to be dried.

### (A3) First Thermal Welding Process

Next, the base foil 12 (first Al foil) that has passed through the drying oven 30 is conveyed to the contacting position of the heat roll pair 28A, 28B via the conveyance roll 26. In the nip portion of the heat roll pair 28A, 28B, the lamination foil 14 (second Al foil) conveyed from another direction is bonded to the surface of the base foil 12 (first Al foil) to which the adhesive 40 is applied. The base foil 12 (first Al foil) and the lamination foil 14 (second Al foil) are thermally welded via the adhesive 40 (first adhesive layers) by being heated and pressed by the heat roll pair 28A, 28B. Thus, as the winding foil 10, a foil in which the first Al foil and the second Al foil are thermally welded (hereinafter referred to as “double Al foil”) is obtained.

Subsequently, a Cu foil is stacked using the current collector foil manufacturing apparatus shown in FIG. 3 again.

### (B1) Second Coating Step

Specifically, in the current collector foil manufacturing device 100 shown in FIG. 3, a double Al foil obtained as described above is used for the base foil 12, a Cu foil is used for the lamination foil 14, and an adhesive for forming the second adhesive layer is used for the adhesive 40. The double Al foil, which is the base foil 12, is conveyed to a pair of rolls composed of a coating roll 22A (for example, a gravure roll) and a counter roll 22B. The adhesive 40 (adhesive for forming the second adhesive layer) adhered to the surface of the coating roll 22A is applied (for example, gravure applied) to one surface of the base foil 12 (double Al foil) from the coating roll 22A.

### (B2) Second Drying Step

Next, the base foil 12 (double Al foil) having passed through the contacting position with the coating roll 22A is conveyed to the drying oven 30 via the conveyance roll 24. In the conveyance path 30, the adhesive 40 on the base foil 12 (double Al foil) is heated in the drying oven 30 to be dried.

### (B3) Second Thermal Welding Process

Next, the base foil 12 (double Al foil) that has passed through the drying oven 30 is conveyed to the contacting position of the heat roll pair 28A, 28B via the conveyance roll 26. In the nip portion of the heat roll pair 28A, 28B, the lamination foil 14 (Cu foil) conveyed from another direction is bonded to the surface of the base foil 12 (double Al foil) to which the adhesive 40 is applied. The base foil 12 (double Al foil) and the lamination foil 14 (Cu foil) are thermally welded to each other via the adhesive 40 (second adhesive layer) by being heated and pressed by the heat roll pair 28A, 28B. Through these steps, as the winding foil 10, a current collector foil in which the first Al foil, second Al foil, and Cu foil are bonded to each other via the first adhesive layer and the second adhesive layer is manufactured.

The heating temperature in the first and second drying steps (the temperature in the drying oven 30 in FIG. 3) can be adjusted by the material of the intervening layer used. For example, the temperature is preferably 80° C. or higher and 200° C. or lower, and more preferably 100° C. or higher and 180° C. or lower.

Further, the heating temperature in the first and second thermal welding steps (the temperature of the heat roll pair 28A, 28B in FIG. 3) can be adjusted by using the intervening layers. For example, the temperature is preferably 50° C. or higher and 150° C. or lower, and more preferably 70° C. or higher and 120° C. or lower. Further, the pressure applied in the first and second thermal welding step (the nip pressure by the heat roll pair 28A, 28B in FIG. 3) is preferably, for example, 0.20 MPa or more and 0.70 MPa or less. 0.30 MPa or more and 0.60 MPa or less is more preferable.

### Liquid Cell

A liquid cell according to an embodiment of the present disclosure includes a current collector foil for a liquid cell according to the embodiment of the present disclosure, a positive electrode active material layer, a negative electrode active material layer, a separator, and an electrolyte solution.

### Positive Electrode Active Material Layer

The positive electrode mixture layer includes a positive electrode active material, and may further include, for example, a binder. Examples of the positive electrode active material include a lithium nickel-cobalt-manganese complex oxide (hereinafter, sometimes simply referred to as “LNCM”). The simplest LNCM is represented by the following general formula: LiNiₓCo_{y}Mn_{z}O₂ (where x, y, z are 0<x<1, 0<y<1, 0<z<1, x+y+z=1). In addition to Li, Ni, Co, Mn, LNCM may contain other additive elements, such as transition-metal elements other than Ni, Co, Mn, and typical metal elements other than Li. LNCM has a layered crystalline architecture. LNCM may be more than 50% by mass of the entire positive electrode active material, for example, 80 to 100% by mass. The positive electrode active material may be composed only of LNCM. Examples of other positive electrode active materials include a lithium nickel composite oxide, a lithium cobalt composite oxide, and a lithium nickel manganese composite oxide.

Examples of the binder included in the positive electrode mixture layers include vinyl halide resins such as polyvinylidene fluoride (PVdF). The positive electrode mixture layer may further contain other components such as a conductive material. Examples of the conductive material include hardly graphitized carbon, easily graphitized carbon such as carbon black, and graphite.

### Negative Electrode Active Material Layer

The negative electrode active material layer described above is used as the negative electrode active material layer. Details have already been described, and therefore will be omitted here.

### Separator

The separator is an electrically insulating porous film. The separator electrically isolates the positive electrode and the negative electrode. The separator may have a thickness of, for example, 5 μm to 30 μm. The separators may be formed of, for example, a porous polyethylene (PE) membrane, a porous polypropylene (PP) membrane, or the like. The separator may have a multilayer structure. For example, the separators may be formed by laminating a porous PP membrane, a porous PE membrane, and a porous PP membrane in this order. The separator may have a heat resistant layer on its surface. The heat resistant layer includes a heat resistant material. Examples of the heat resistant material include metal oxide particles such as alumina, and high melting point resins such as polyimide.

### Electrolyte Solution

A cell according to an embodiment of the present disclosure further includes an electrolyte solution. In particular, a non-aqueous electrolyte solution is preferable.

### Solvent

The non-aqueous electrolyte solution contains a solvent (non-aqueous solvent) and an electrolyte. Examples of the solvent (non-aqueous solvent) include N,N-diethyl-N-methyl-N-(2-methoxyethyl) ammonium bis(fluorosulfonyl)imide (DEME), 1-ethyl-3-methylimidazolium bis(fluorosulfonyl)imide (EMI), and 1-ethyl-2,3-dimethylimidazolium bis(fluorosulfonyl)imide (DEMI-FSI).

### Electrolyte

Examples of the electrolyte in the electrolyte solution include Li. Examples of Li salt include lithium bis(fluorosulfonyl)imide (LiFSI), LiPF₆ (lithium hexafluoride phosphate), lithium tetrafluoroborate (LiBF₄), Li [N(CF₃SO₂)₂]. The amount of electrolyte may be, for example, 1.0 mol/L to 2.0 mol/L, preferably 1.0 mol/L to 1.5 mol/L.

The electrolyte solution may contain, in addition to the solvent and the electrolyte, various additives such as a thickener, a film forming agent, a gas generating agent, and the like. The electrolyte is typically a liquid non-aqueous electrolyte solution at room temperature (e.g., 25±10° C.). The electrolyte solution typically exhibits a liquid state in the use environment of the cell (e.g., in a temperature environment of −20° C. to +60° C.).

### Use

The cell according to the disclosed embodiments can be used in, for example, power supplies such as hybrid electric vehicle (HEV), plug-in hybrid electric vehicle (PHEV), battery electric vehicle (BEV).

Hereinafter, the present disclosure will be described based on Examples, but the present disclosure is not limited to these Examples in any way.

### Preparation of Adhesive

An adhesive 1 was obtained by mixing an olefinic resin as a main agent, an isocyanate-based curing agent, and Ni plated particles as a conductive auxiliary agent.

### Preparation of Current Collector Foil

An adhesive 1 was used as the adhesive 40 in the current collector foil manufacturing device 100 shown in FIG. 1, a first aluminum foil (first Al foil) having a pinhole was used as the base foil 12, and a second aluminum foil (second Al foil) having a pinhole was used as the lamination foil 14. The thicknesses of both the first Al foil and the second Al foil were 40 μm. In addition, the line speed (conveyance speed) was set to 15 m/min.

Adhesive 1 was applied to one surface of the first Al foil by gravure coating (coating step). This layer of adhesive 1 is referred to as a “first adhesive layer”. A gravure roll (an elongate, 75 lines) was used as the coating roll 22A.

Next, the first Al foil coated with the adhesive 1 (first adhesive layer) was passed through a drying oven 30 having a temperature of 150° C. to dry the adhesive 1 (drying step). Thereafter, with respect to the first Al foil conveyed to the heat roll pair 28A, 28B, the second Al foil was bonded to the surface to which the adhesive 1 was applied and heat-welded (thermal welding step) to obtain a foil in which the first Al foil and the second Al foil were thermally welded (hereinafter referred to as “double Al foil”). The conditions of the heat roll pair 28A, 28B were as follows.
Temperature of the heat roll pair: 90° C.
Nip pressure of the heat roll pair: 0.45 MPa

Next, a double Al foil was used as the base foil 12 in the current collector foil manufacturing device 100 shown in FIG. 1, and a copper foil (Cu foil) was used as the lamination foil 14. The thickness of Cu foil was 7.8 μm. The line speed (conveyance speed) was the same as above.

Adhesive 1 was applied to one surface of the double Al foil (surface on the second Al foil side) by gravure coating (coating step). This layer of adhesive 1 is referred to as a “second adhesive layer”. Next, the double Al foil coated with the adhesive 1 (second adhesive layer) was passed through a drying oven 30 having a temperature of 150° C. to dry the adhesive 1 (drying step). After that, the double Al foil conveyed to the heat roll pair 28A, 28B was thermally welded by bonding Cu foil to the surface to which the adhesive 1 was applied (heat welding step). The conditions of the heat roll pair 28A, 28B were the same as described above. Thus, the current collector foil of the example was obtained. The thicknesses of the first adhesive layer and the second adhesive layer were 3.0 μm.

### Comparative Example

### Preparation of Current Collector Foil

An adhesive 1 was used as the adhesive 40 in the current collector foil manufacturing device 100 shown in FIG. 1, an aluminum foil (Al foil) having pinholes was used as the base foil 12, and a copper foil (Cu foil) was used as the lamination foil 14. The thickness of Al foil was 40 μm, and the thickness of Cu foil was 7.8 μm. In addition, the line speed (conveyance speed) was the same as that of the example. Adhesive 1 was applied to one surface of Al foil by gravure coating (coating step). The conditions of the coating roll 22A were the same as those in the embodiment.

Next, Al foil coated with the adhesive 1 was passed through a drying oven 30 having a temperature of 150° C. to dry the adhesive 1 (drying step). Thereafter, Cu foil was bonded to the surface to which the adhesive 1 was applied to Al foil conveyed to the heat roll pair 28A, 28B and thermally welded (heat welding step). The conditions of the heat roll pair 28A, 28B were the same as in the embodiment. Thus, a current collector foil of the comparative example was obtained. Note that the thickness of the layer of the adhesive 1 was 3.0 μm.

### Evaluation Test

### Pinhole Inspection

For each of the current collector foils obtained in the example and the comparative example, whether there was a pinhole with a diameter of 0.5 mm or less was detected using an inspector. The results are shown in Table 1 below.

TABLE 1

| | Pinhole (Count) | | | | |
|---|---|---|---|---|---|
| | | More | More | More | |
| | Over 0.1 | Than | Than | Than | |
| | mm | 50 μm | 20 μm | 10 μm | 10 μm |
| | 0.5 mm or | 0.1 mm or | 50 μm or | 20 μm or | or |
| | Less | Less | Less | Less | Less |
| Example | 0 | 0 | 0 | 0 | 0 |
| Comparative | 0 | 7 | 11 | 5 | 0 |
| Example | | | | | |

In the current collector foil of the example in which two Al layers having pinholes are stacked, it can be seen that the number of pinholes can be reduced as compared with the current collector foil of the comparative example in which only one Allayer having pinholes is formed.

What is claimed is:

1. A current collector foil for a liquid cell, the current collector foil comprising:
one first electrode foil having a pinhole;
a first intervening layer;
another first electrode foil having a pinhole;
a second intervening layer; and
a second electrode foil, the one first electrode foil, the first intervening layer, the other first electrode foil, the second intervening layer, and the second electrode foil being stacked in this order, wherein
either the one first electrode foil and the other first electrode foil or the second electrode foil is a positive electrode foil, and either the one first electrode foil and the other first electrode foil or the second electrode foil, whichever is not the positive electrode foil, is a negative electrode foil.

2. A liquid cell comprising: the current collector foil according to claim 1; a positive electrode active material layer; a negative electrode active material layer; a separator; and an electrolyte solution.
